(19) United States
(12) Patent Application Publication
(10) Pub. No.: US 2021/0148507 A1
(43) Pub. Date: May 20, 2021

(54) MOUNTS

(71) Applicants: Roger Alan VINTON, London (GB); Roger Nicholas MCARDELL, London (GB)

(72) Inventors: Roger Alan VINTON, London (GB); Roger Nicholas MCARDELL, London (GB)

(21) Appl. No.: 16/483,312

(22) PCT Filed: Feb. 5, 2018
(86) PCT No.: PCT/EP2018/052828

§ 371 Date: Aug. 2, 2019

(30) Foreign Application Priority Data
Feb. 6, 2017 (GB) 1701947.2

(51) Int. Cl. F16M 13/02; F16M 11/04; F16M 11/16

(52) U.S. Cl. CPC F16M 13/02; F16M 2200/022; F16M 11/16; F16M 11/041

(57) ABSTRACT

A display wall mount, comprising a wall bracket for attachment to a wall or planar structure, the wall bracket comprising a planar back plate, side panels extending from respective opposing sides of the of the back plate, wherein at least one of the side panels includes a cam portion to receive a follower, the cam portion configured to translate motion of the follower relative and parallel to the back plate to perpendicular motion relative to the back plate.

### TECHNICAL FIELD

Aspects relate, in general, to a display wall mount, mounting system, mounting plate and to a method.

### BACKGROUND

Displays, such as a televisions and monitors, which can be used for meetings and videoconferencing for example, can be wall or plinth mounted. In the former case, wall mounts or supports can be provided that are fixed to a wall in a suitable location. The display can then be mounted to the support. Cabling required to power the display and provide any input/output signals typically trails from the bottom or side of the device, and can be connected to suitable power and data outlets situated close to the device.

Mounting display devices can be difficult and time consuming. For example, the need to offer-up a display to a mount so as to enable any fixing points to line up whilst ensuring that the alignment is maintained while the display is affixed to the mount can be tricky given the weight and awkward positioning that is inherent in mounting devices high up on walls. Furthermore, the provision of cables trailing from the mount can be unsightly and dangerous. There is typically also a large amount of wasted space behind the display that is taken up by the wall mount such the display sits proud from the wall by a fairly significant degree. In small spaces, this can be problematic as it may mean that users of a device are too close to sensible or safely be able to use or view the display. In addition, the mounts can be unsightly.

### SUMMARY

According to an example, there is provided a display wall mount, comprising a wall bracket for attachment to a wall or planar structure, the wall bracket comprising a planar back plate and side panels extending from respective opposing sides of the of the back plate, wherein at least one of the side panels includes a cam portion to receive a follower, the cam portion configured to translate motion of the follower relative and parallel to the back plate to perpendicular motion relative to the back plate. The back plate can be configured to sit, in use, flush to a wall or other structure upon which the wall mount is mounted. The side walls can extend from the back plate in a direction that is perpendicular to the plane of the back plate. At least one of the side panels can comprise a locking mechanism configured to secure a display to the wall mount. The planar back plate and the side walls can define an enclosure or volume to receive cabling for a display to be mounted. The cam portion can comprise an opening on the side panel defining a channel to receive a follower, the profile of the channel configured to cause, in use, the follower to move towards the back plate.

According to an example, there is provided a method of mounting a display to a wall, the method comprising securing a display wall mount as claimed in any preceding claim to the wall or structure by fixing the planar back plate flush therewith using fixing means and mounting the display to the display wall mount by locating at least one follower attached to the display within a cam portion of the display wall mount and lowering the display whereby to cause the follower to travel along the cam portion. The cam portion can be so arranged as to enable the display to be mounted flush to the wall. The method can further comprise providing display cabling within an enclosure, cavity or volume defined by the planar back plate and the side walls.

According to an example there is provided a mounting system, comprising a display wall mount as provided herein and a mounting plate to releasably attach to the rear of a display, the mounting plate comprising at least one follower configured to engage with a cam portion of the display wall mount. The mounting plate can comprise multiple fixing apertures to receive fixing means to enable the mounting plate to be releasably attached to the rear of the display. The mounting plate can comprise at least one aperture on a rear face thereof. An inwardly depending portion on at least one side wall of the mounting plate can be provided to receive or which is provided with a follower. An aperture can be provided on the inwardly depending portion to receive a fixing means. At least one venting portion can be provided. The multiple fixing apertures can be configured in a predetermined pattern whereby to accommodate multiple differently sized displays utilising a fixing standard.

According to an example there is provided a mounting plate for releasably attaching to the rear of a display, the mounting plate comprising at least one follower configured to engage with a cam portion of a display wall mount as provided herein. The mounting plate can further comprise multiple fixing apertures to receive fixing means to enable the mounting plate to be releasably attached to the rear of the display. The mounting plate can further comprise at least one aperture on a rear face thereof. The mounting plate can further comprise an inwardly depending portion on at least one side wall thereof to receive or which is provided with a follower. The mounting plate can further comprise an aperture on the inwardly depending portion to receive a fixing means. The mounting plate can further comprise at least one venting portion. The multiple fixing apertures can be configured in a predetermined pattern whereby to accommodate multiple differently sized displays utilising a fixing standard.

### BRIEF DESCRIPTION OF THE DRAWINGS

Embodiments will now be described, by way of example only, with reference to the accompanying drawings, in which:

FIG. 1 is a schematic representation of a display wall mount according to an example;

FIG. 2 is schematic representation of a side wall according to an example;

FIG. 3 is schematic representation of a portion of the side wall shown in FIGS. 1 and 2 according to an example;

FIG. 4 is schematic representation of a display wall mount according to an example;

FIG. 5 is a schematic representation of the back of a display according to an example;

FIG. 6 is a schematic representation of a follower according to an example;

FIG. 7 is a schematic representation of a follower is situ in a cam portion according to an example;

FIG. 8 is schematic representation of the bottom region of a display casing according to an example;

FIG. 10 is a schematic representation of a mount according to an example in situ in the cavity of a display casing;

FIG. 11 is a schematic representation of a mount according to an example in situ in the cavity of a display casing; and

FIGS. 12 to 16 are schematic representations of a mounting plate according to an example.

### DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

According to an example, there is provided a display wall mount, comprising a wall bracket for attachment to a wall, the wall bracket comprising a planar back plate and side panels extending from respective opposing sides of the of the back plate, wherein at least one of the side panels includes a cam portion to receive a follower, the cam portion configured to translate motion of the follower relative and parallel to the back plate to perpendicular motion relative to the back plate. In an example, the follower can be provided on a display or as part of a mounting plate configured to attach to a display.

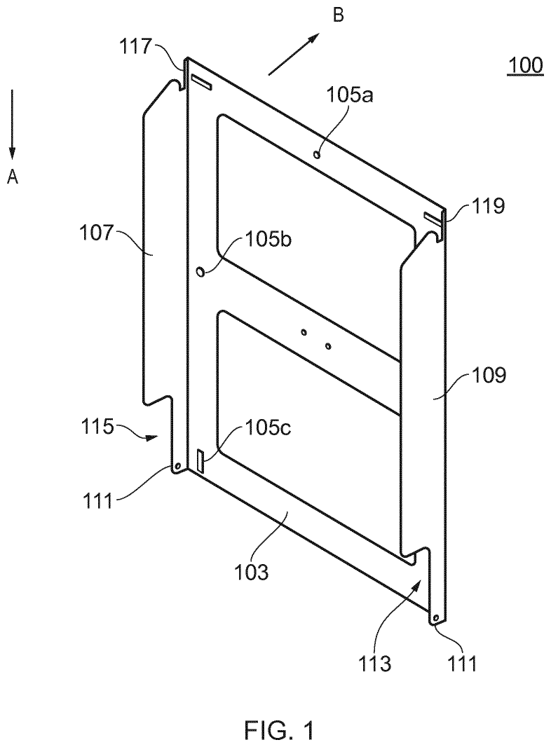

FIG. 1 is a schematic representation of a display wall mount according to an example. The display wall mount 100 fits to a wall and enables a display to be fitted flush to the wall whilst enclosing unsightly cables and connectivity. This is a major benefit in meeting rooms where a number of cables and connections are usually visible from the side of the screen as you enter the room or drop out from below the display. As used herein, the term wall can also encompass an upright and generally planar surface or structure to which a mount may be fixed and its use is not intended to be limiting.

Typically, fitting displays to wall brackets is a fiddly and awkward job as there is a need to align screws or other fixings whilst holding the display in the right place. The black plate 103 of the display wall mount 100 according to an example is configured to sit flush to a wall upon which the wall mount is mounted. The back plate can be secured to the wall using suitable fixings such as screws or bolts for example, which pass through holes 105a-c in the back plate 103. More or fewer such holes may be present, and it will be appreciated that not all may be visible in FIG. 1 due to occlusion as a result of the perspective view.

The side walls 107, 109 of the display wall mount 100 extend from the back plate 103 in a direction that is perpendicular to the plane of the back plate, as can be seen in FIG. 1. That is, for example, when the back plate 103 is mounted or fixed to a wall the side walls 107, 109 extend outwardly from the wall at a right angle. In an example, the side plates 107, 109 may extend at some other angle to the back plate. In the example of FIG. 1 the side walls 107, 109 are parallel to one another, but they may be angles with respect to one other, particularly if, for example, the back plate from which the side walls depend is not square or rectangular.

At least one of the side walls 107, 109 comprises a locking mechanism 111 configured to secure a display to the wall mount 100. Two such mechanisms are shown in FIG. 1, one on each side wall. In an example, the locking mechanism is in the form an aperture in the side wall that enables a screw or bolt or similar to pass through so that a display can be releasably fixed to the side wall at the location of the locking mechanism.

In an example, the planar back plate 103 and the side walls 107, 109 define an enclosure or volume to receive cabling for a display to be mounted. For example, cables required to power a display and provide input/output data can be housed in the volume defined by the back plate and side walls and can pass through an opening 113, 115 in on one or both of the side walls for example.

According to an example, a cam portion 117, 119 can be provided in or on at least one of the side walls. In the example shown in FIG. 1, a cam portion is depicted in each of the side walls. When the mount 100 is fixed on a wall, the cam portions are arranged at the top of the side walls and comprise an opening defining a channel to receive a follower. The profile of the channel is configured to cause, in use, the follower to move towards the back plate. That is, movement of a follower in the channel defining a cam portion in the direction A as shown in FIG. 1 will cause the follower to move in direction B such that a downward motion of a follower in a cam portion pulls the follower back towards the back plate. As such, a follower that is fixed to a display can be used to mount the display to the mount 100 and enable the display to be pulled back towards the wall onto which the back plate of the mount is fixed, thereby enabling the display to sit flush with the wall. In this connection, the side walls and profile of the channels defining the cam portions can be so selected as to match the display such that it sits flush with a wall once the follower is at rest at the bottom of the channel defining a cam portion. As noted above, one or more followers can be provided on a plate that can be attached to a display. For example, a standard compliant (e.g. VESA) plate can be used. The plate can be attached to a display and can comprise at least one follower configured to engage with a corresponding cam portion of a mount 100.

In an example, a cam portion can be provided on one or both side walls. Preferably, a cam portion is provided on each side wall, as depicted in FIG. 1, in order to increase stability of a mounted display.

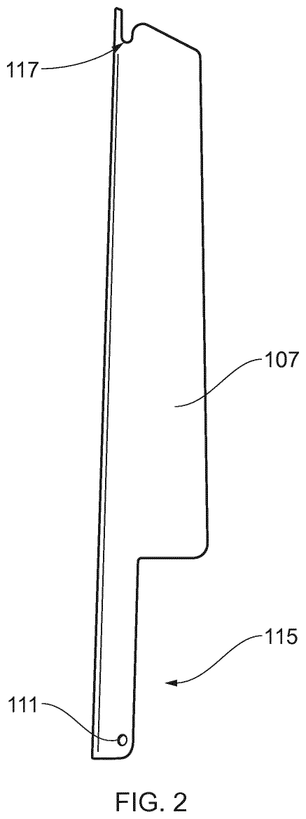

FIG. 2 is schematic representation of a side wall according to an example. In the example of FIG. 2, and referring to FIG. 1, side wall 107 is shown and cam portion 117 is visible as is locking mechanism 111 and opening 115.

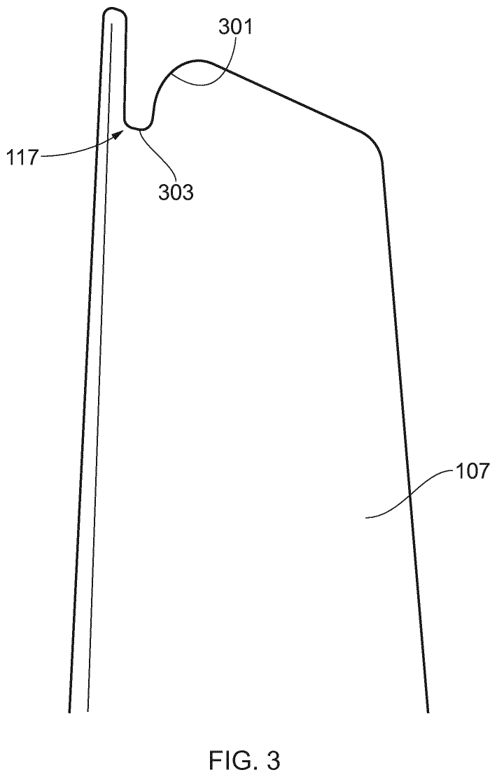

FIG. 3 is schematic representation of a portion of the side wall shown in FIGS. 1 and 2 according to an example. In the example of FIG. 3, the profile of the channel of the cam portion 117 is visible. As can be seen, the channel has a pronounced curved portion 301 and bottom portion 303 in which a follower can come to rest and be supported. In use, a follower will pass over the curve 301 and be forced backwards towards the wall onto which the back plate is mounted as a result of the downward motion of the follower that results from lowering a display (onto which the follower is attached) onto the mount. A different profile to that depicted can be used provided that it causes downward motion of a follower, relative to a fixed back plate, to translate to motion that is perpendicular to the back plate and directed in towards the wall onto which the back plate is fixed. That is, a different profile can be selected providing that it causes a display to be mounted to sit flush to the wall onto which the mount is fixed once the display is in place on the mount and followers fixed to or associated with the display are at rest in the bottom 303 of the channels defining the cam portions.

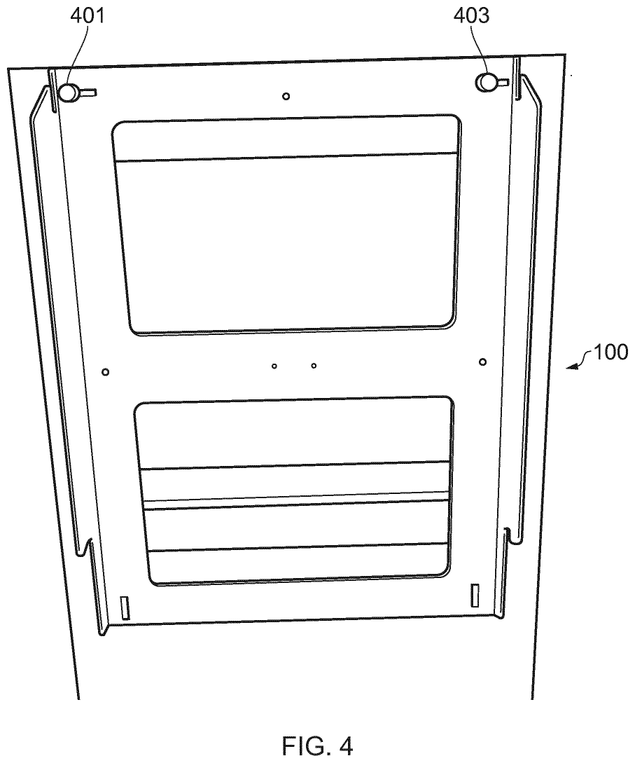

FIG. 4 is schematic representation of a display wall mount according to an example. In the example of the FIG. 4, the mount can be seen fixed to an upright structure and fixings 401, 403 used to secure the mount to the structure are visible. As will be appreciated, more or less of such fixings may be used, such as at the bottom and/or middle of the mount and so on. As can be seen in FIG. 4, the back plate is flush to the structure to which it is fixed.

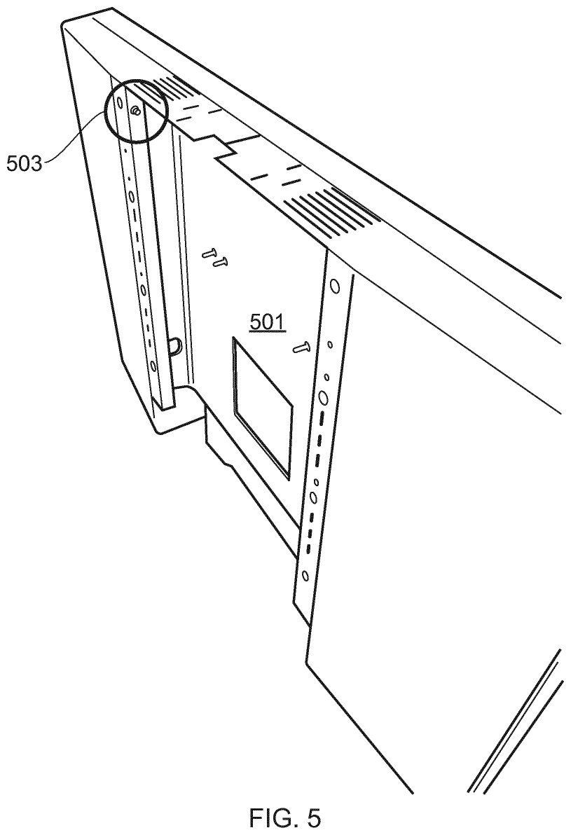

FIG. 5 is a schematic representation of the back of a display according to an example. The display is suitable for use with a mount as described herein and includes a cavity 501 that is so profiled as to have the same or similar dimensions as the mount and to receive the side walls of a mount therein. A follower 503 attached to the display is provided as shown, and another may be provided on the other side of the cavity (not visible in this figure).

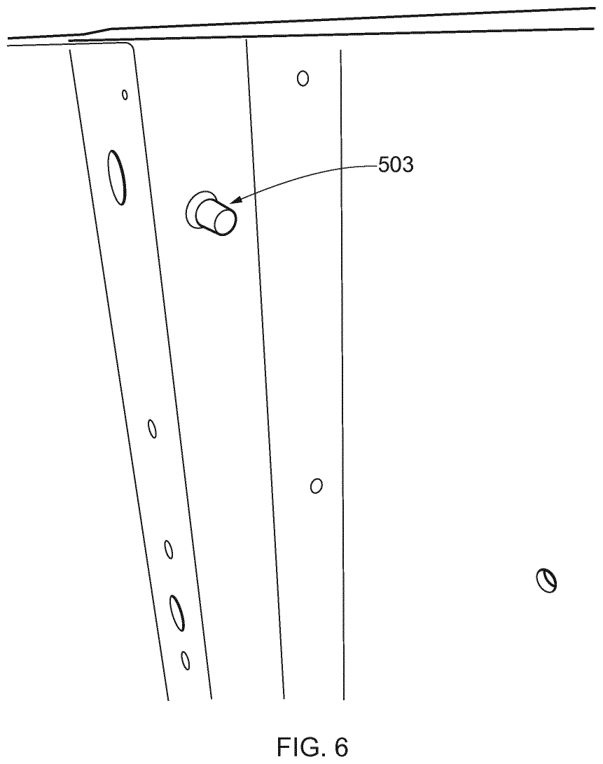

FIG. 6 is a schematic representation of a follower according to an example. Specifically, as shown in FIG. 6, the follower 503 is shown attached to the display. In the example shown in the figures, the follower is in the form of a cylindrical protruding portion, which may be integrally formed with a display casing or subsequently affixed thereto. The follower 503 can protrude by any degree sufficient to enable it to engage in a cam portion whilst not interfering with any other part of the display or mount. Typically, as can be seen, it will protrude about 1 cm.

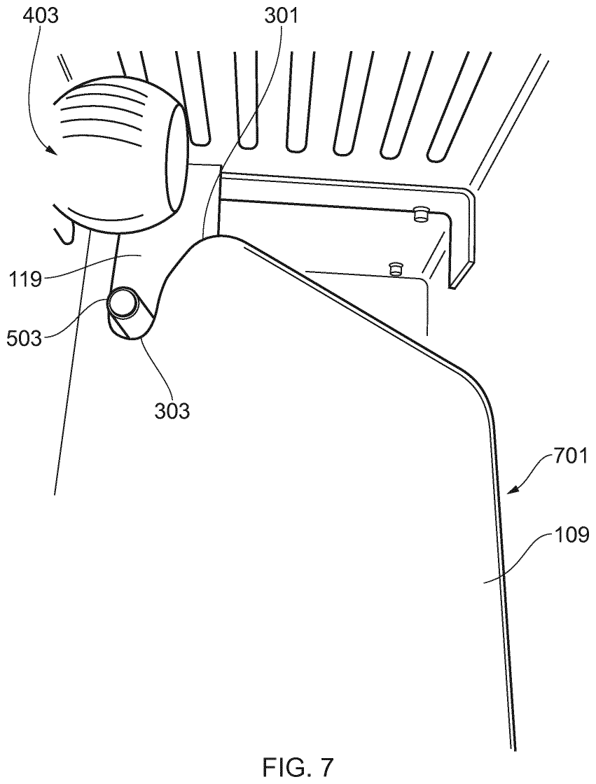

FIG. 7 is a schematic representation of a follower is situ in a cam portion according to an example. As can be seen in FIG. 7, follower 503 is at rest in the bottom 303 of the channel defining cam portion 119. The back of the display casing can be seen to be in contact or very close to the edge 701 of the side wall 109. That is, as can be seen, the profile of the cavity in the display casing in which the mount is received is geared to reduce wasted space and enable the mount to fit snugly within that cavity. It will of course be realised that other configurations are possible, and this is not intended to be limiting.

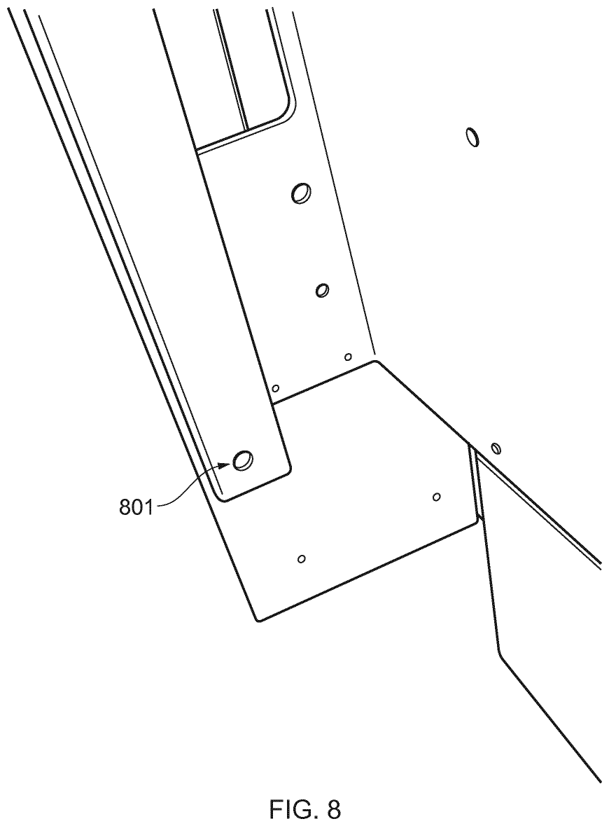

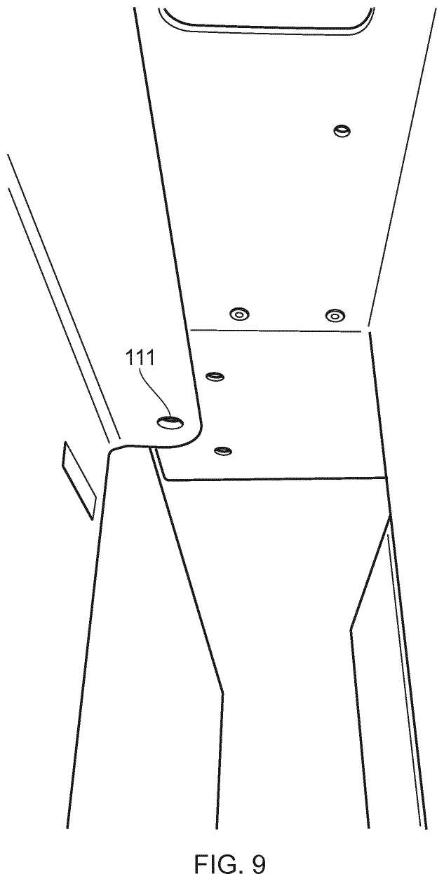

FIG. 8 is schematic representation of the bottom region of a display casing according to an example. An aperture 801 is visible. With reference to FIG. 9, it can be seen that this aperture is configured to align with a corresponding aperture III on a side wall of the mount to enable the casing to be secured.

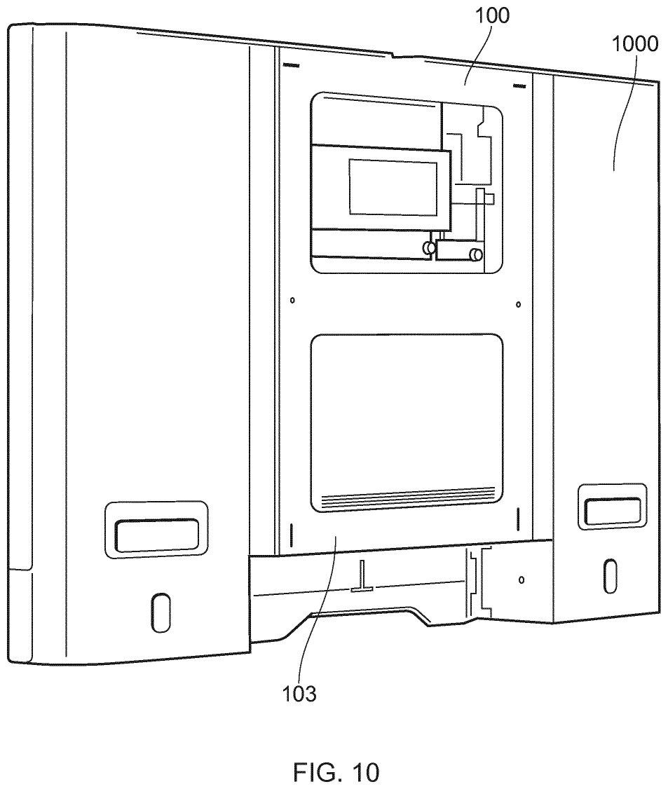

FIG. 10 is a schematic representation of a mount according to an example in situ in the cavity of a display casing. As can be seen, the rear of the back plate 103 of the mount 100 lies flush with the rear of the display casing 1000. As such, the back plate and the rear of the display casing mounted thereon will sit flush to a wall or other planar structure to which the mount is fixed.

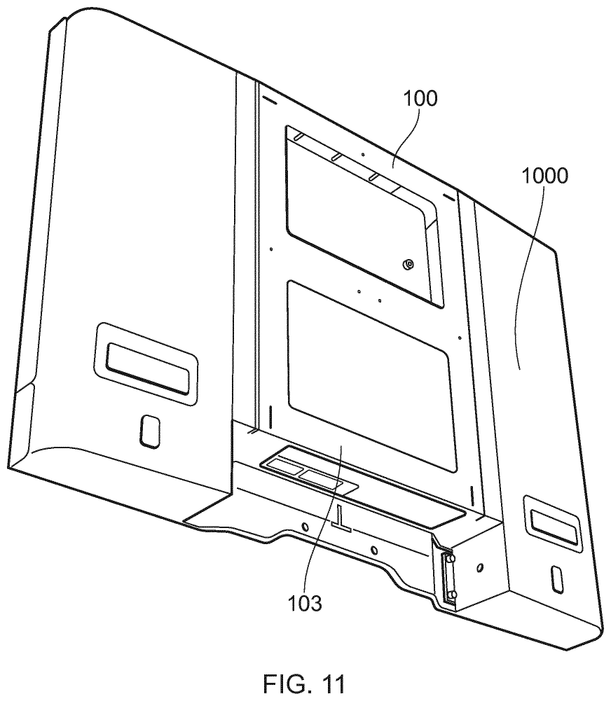

FIG. 11 is a schematic representation of a mount according to an example in situ in the cavity of a display casing. As depicted in FIG. 11, a cavity can be seen beneath the wall mount. This can be used for access to cabling interfaces and so on.

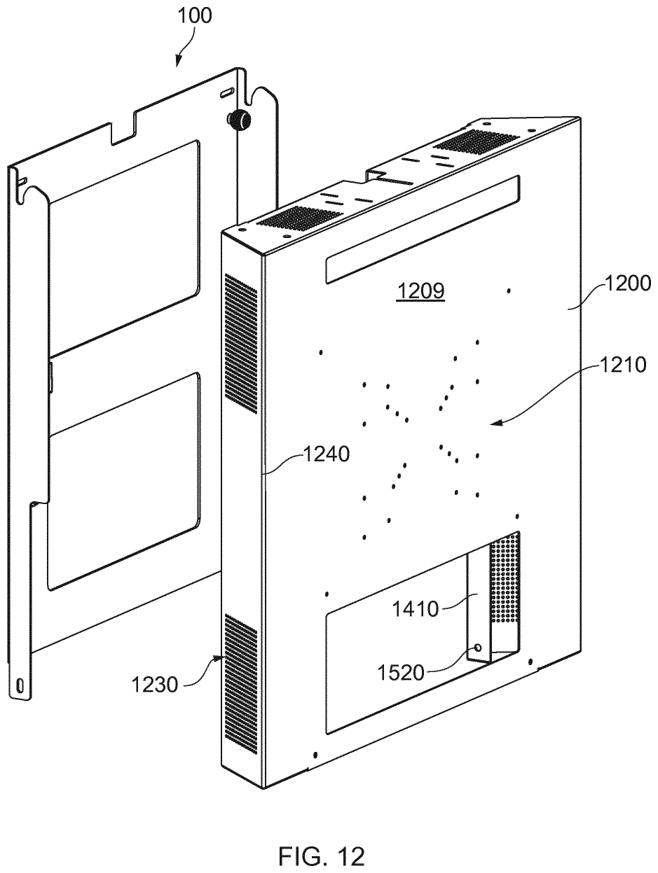

FIG. 12 is a schematic representation of a mounting plate according to an example. Plate, cage or rack 1200 is suitable for use with a display and may be configured for use with a specific display or for use with displays adhering to a standard, such as the VESA standard for example, and more particularly displays comprising a Flat Display Mounting Interface (FDMI) or adhering to the VESA Mounting Interface Standard. In either case, plate 1200 can be releasably attached to the rear of a display to enable the display to be mounted using the mount as described hereinbefore.

In the example of FIG. 12, multiple fixing points 1210 are provided on plate 1200. The fixing points 1210 are arranged to enable the plate to be fitted to a multitude of displays of varying sizes (and which therefore comprise different combinations of corresponding fixing apertures). In an example, fixing points 1210 can be apertures that extend through the plate 1200 thereby enabling fixing means, such as a screw or bolt for example, to be passed through to engage with a corresponding hole in the back of a display. In an example, fixing point 1210 are arranged in a selected configuration that corresponds to a standard mounting interface (such as noted above for example). However, any desired configuration can be used, and fixing points 1210 can be in the form of apertures and/or channels.

Similarly to that described above, with reference to FIG. 5 for example, the plate 1200 can define a cavity within which cabling for the display may be placed or stored. Plate 1200 comprises at least one follower or pin with the same function and a similar position to follower 503 of FIG. 5 for example. Accordingly, plate 1200 can be fixed to the rear of a display using suitable fixings such as screws for example. The plate can be fixed using mounting interface apertures at the rear of the display provided as part of a mounting standard to which the display manufacturer adheres or which are provided to enable the display to be mounted. Once fixed to the rear of the display, the pins on the plate, such as on either side to the plate 1200 for example (not visible in the example of FIG. 12) can be used with the mount 100 as described above to seat the display flush a wall onto which the mount is fixed.

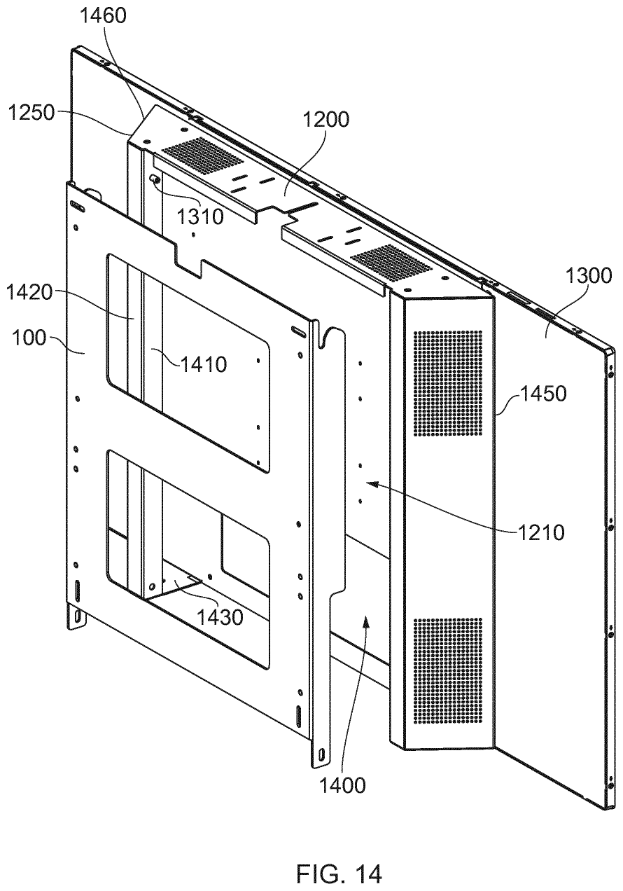

In an example, plate 1200 can comprise one or more areas 1230 in which venting, grating, holes etc. can be provided. This can enable air to circulate and/or excess heat from a display to dissipate when mounted. The area 1230 can be provided on a side wall 1240 of the plate 1200. Corresponding side wall 1250 and top wall 1260, extending from the rear 1209 of the plate 1200 are provided. The rear 1209, side walls 1240, 1250 and top wall 1260 define cavity 1400 (see FIG. 14) and provide stability.

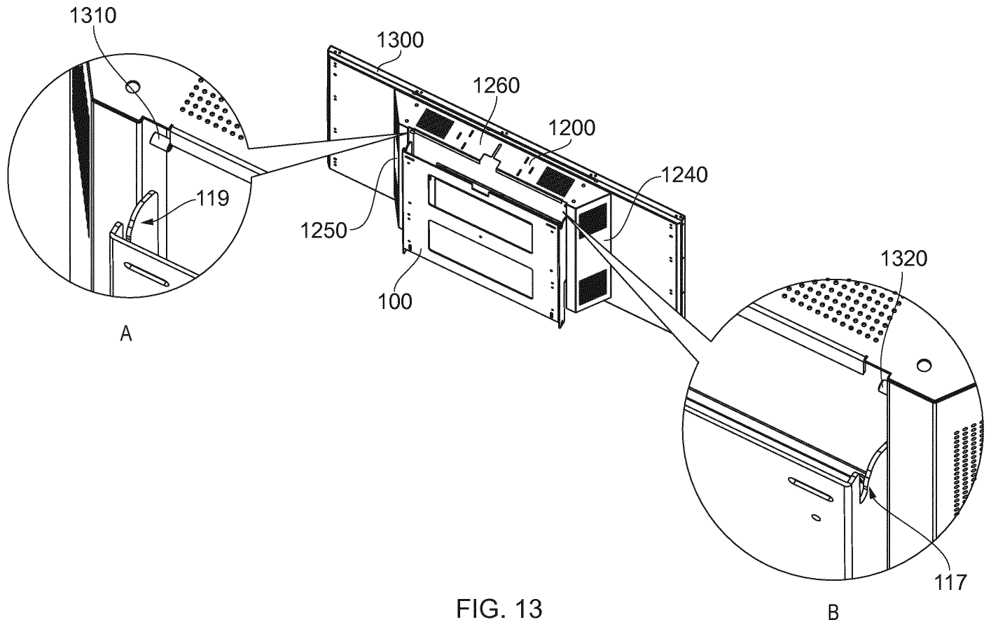

FIG. 13 is a schematic representation of a mounting plate according to an example. More particularly, FIG. 13 shows mounting plate 1200 attached to the back of a display 1300. A wall mounting portion 100 (as shown in and described with reference to FIGS. 1 to 11 for example) is shown. Exploded portions of FIG. 13 (A and B) show pins 1310, 1320 provided on either side of the plate 1200. Similarly to that described above with reference to FIGS. 1 to 11 for example, pins 1310, 1320 engage with corresponding cam portions 117, 119 of plate 100. In an example, followers 1310, 1320 are provided on side walls 1250, 1240 respectively.

Thus, in use, the plate 1200 is fixed to the rear of display 1300 using suitable fixing means through apertures 1210. Plate 100 is attached to a wall for example, at a desired location. The fixing means used can enable the mount to be removed from the display if desired, and may be screws or bolts for example. The display plus plate can then be offered up to the plate 100 so that pins 1310, 1320 engage into the channels defined by the portions 119, 117. Gravity then causes the display to move down relative to the plate 100 with caromed portions 117, 119 causing the display to be pulled backwards towards the surface onto which the plate 100 is mounted, thereby giving a robust and flush fit for the display.

FIG. 14 is a schematic representation of a mounting plate according to an example. As can be seen more clearly in FIG. 14, a cavity 1400 defined by plate 1200 is provided. As best seen in FIG. 14, follower 1310 is provided on a side wall portion 1410 of side wall 1250. In an example, to lend strength for example, this portion 1410 extends the length of the side wall 1250 and depends inwardly (i.e. toward rear wall 1209 of plate 1200) from the side wall 1250. A portion 1420, substantially parallel to rear wall 1209, can be provided from which the portion 1410 depends. The same arrangement can be provided in relation to the other side wall 1240. The portions 1410 and 1420 can be connected to the top wall 1260 and to a bottom section 1430 that is also connected to rear wall 1209 for example. In an example, side walls 1240, 1250 depend from the rear wall 1209 at an inward (away from edges 1450, 1460 or rear wall 1209) slant (rather than perpendicularly for example), although it will be appreciated that they may depend perpendicularly from rear wall 1209.

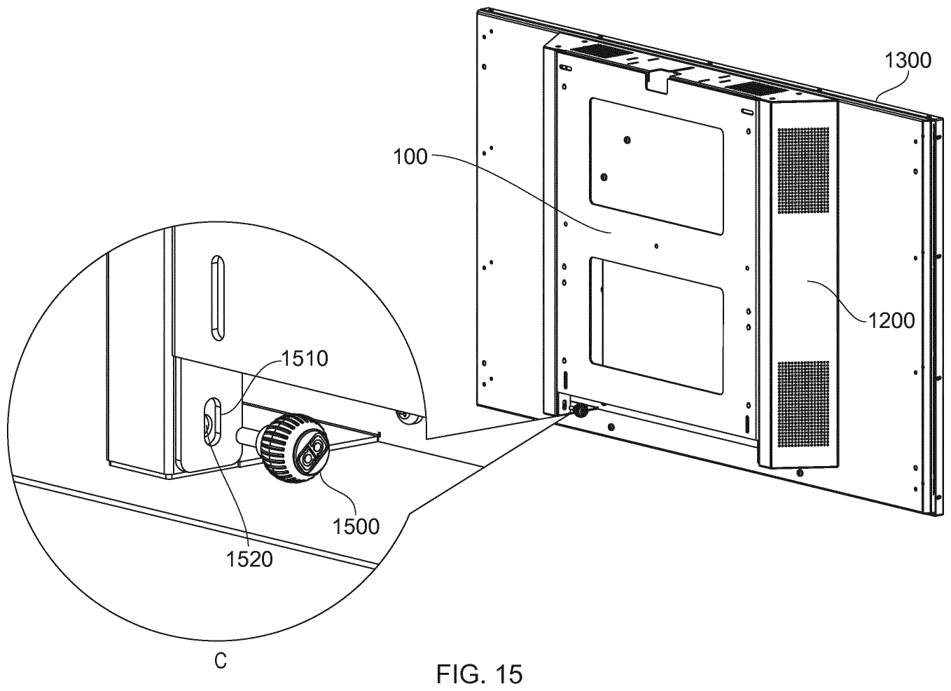

FIG. 15 is a schematic representation of a mounting plate according to an example. In the example of FIG. 15, exploded portion C depicts a fixing means 1500 that can be used to secure the mount 1200 attached to the rear of the display 1300 to the plate 100. A similar fixing process can be applied to the other side (not visible in this figure). The fixing means 1500 pass through an aperture or channel 1510 in the plate 100 to engage into a corresponding portion 1520 in the plate 1200. Fixing means 1500 can be screw threaded and portion 1520 can comprise a corresponding threaded portion for example. Portion 1520 is provided in the side wall portion 1410. A similar arrangement can be provided on the other side wall of the plate 1200.

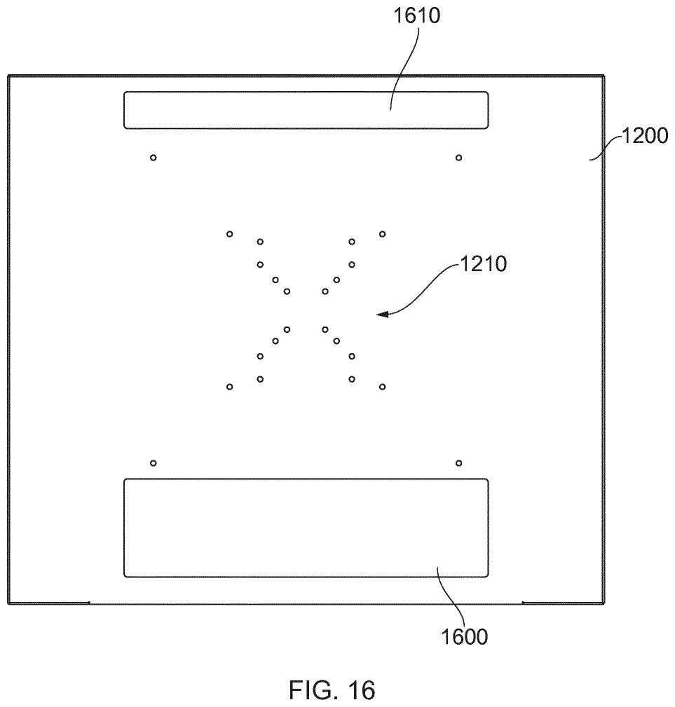

FIG. 16 is a schematic representation of a mounting plate according to an example. FIG. 16 shows the rear of the plate 1200. Fixing portions 1210 are visible. One or more access apertures 1600, 1610 can be provided to enable access to cabling and so on that resided in the cavity defined by the plate 1200 when in situ on a display 1300. The aperture are disposed on the rear face of the plate 1200, which is the face that is adjacent display 1300 in use.

The present inventions can be embodied in other specific apparatus and/or methods. The described embodiments are to be considered in all respects as illustrative and not restrictive. In particular, the scope of the invention is indicated by the appended claims rather than by the description and figures herein. All changes that come within the meaning and range of equivalency of the claims are to be embraced within their scope.

1. A display wall mount, comprising:
a wall bracket for attachment to a wall or planar structure, the wall bracket comprising:
a planar back plate;
side panels extending from respective opposing sides of the of the back plate, wherein at least one of the side panels includes a cam portion to receive a follower, the cam portion configured to translate motion of the follower relative and parallel to the back plate to perpendicular motion relative to the back plate.

2. The display wall mount as claimed in claim 1, wherein the back plate is configured to sit, in use, flush to a wall upon which the wall mount is mounted.

3. The display wall mount as claimed in claim 1, wherein the side walls extend from the back plate in a direction that is perpendicular to the plane of the back plate.

4. The display wall mount as claimed in claim 1, wherein at least one of the side panels comprises a locking mechanism configured to secure a display to the wall mount.

5. The display wall mount as claimed in claim 1, wherein the planar back plate and the side walls define an enclosure to receive cabling for a display to be mounted.

6. The display wall mount as claimed in claim 1, wherein the cam portion comprises an opening on the side panel defining a channel to receive a follower, the profile of the channel configured to cause, in use, the follower to move towards the back plate.

7. (canceled)

8. (canceled)

9. (canceled)

10. A mounting system, comprising:
a display wall mount as claimed in claim 1; and
a mounting plate defining a cavity, the mounting plate to releasably attach to the rear of a display, the mounting plate comprising:
at least one follower configured to engage with a cam portion of the display wall mount.

11. (canceled)

12. (canceled)

13. The mounting system as claimed in claim 10, further comprising an inwardly depending portion on at least one side wall of the mounting plate to receive or which is provided with the follower.

14. The mounting system as claimed in claim 13, further comprising an aperture on the inwardly depending portion to receive a fixing means.

15. The mounting system as claimed in claim 10, further comprising at least one venting portion.

16. The mounting system as claimed in claim 11, wherein the multiple fixing apertures are configured in a predetermined pattern whereby to accommodate multiple differently sized displays utilising a fixing standard.

17. A mounting plate for releasably attaching to the rear of a display, the mounting plate defining a cavity, the mounting plate comprising:
at least one follower configured to engage with a cam portion of a display wall mount as claimed in claim 1.

18. The mounting plate as claimed in claim 17, further comprising multiple fixing apertures to receive fixing means to enable the mounting plate to be releasably attached to the rear of the display.

19. The mounting plate as claimed in claim 17, further comprising at least one aperture on a rear face thereof.

20. The mounting plate as claimed in claim, further comprising an inwardly depending portion on at least one side wall thereof to receive or which is provided with a follower.

21. The mounting plate as claimed in claim 20, further comprising an aperture on the inwardly depending portion to receive a fixing means.

22. The mounting plate as claimed in claim, further comprising at least one venting portion.

23. The mounting plate as claimed in claim 18, wherein the multiple fixing apertures are configured in a predetermined pattern whereby to accommodate multiple differently sized displays utilising a fixing standard.

24. The mounting system as claimed in claim 10, wherein the at least one follower is within the cavity.

25. The mounting system as claimed in claim 10, wherein side walls of the display wall mount are so configured as to fit within the cavity.
